(19) United States
(12) Patent Application Publication
(10) Pub. No.: US 2013/0027317 A1
(43) Pub. Date: Jan. 31, 2013

(54) METHOD FOR PROVIDING DIGITAL SENSING DATA FOR TOUCH PANEL APPARATUS

(71) Applicants: Shua Shen HSIAO, Chiayi City (TW); Chiu Hsia Hsieh, Taipei City (TW); Chien Yu Chan, Hsinchu City (TW)

(72) Inventors: Shua Shen HSIAO, Chiayi City (TW); Chiu Hsia Hsieh, Taipei City (TW); Chien Yu Chan, Hsinchu City (TW)

(73) Assignee: RAYDIUM SEMICONDUCTOR CORPORATION, Hsinchu (TW)

(21) Appl. No.: 13/193,089

(22) Filed: Jul. 28, 2011

(51) Int. Cl. G06F 3/041

(52) U.S. Cl. 345/173

(57) ABSTRACT

A method for providing digital sensing data for a touch panel apparatus comprises the steps of: collecting a stream of digital sensing data from a plurality of operational amplifiers of a touch panel apparatus; generating a first revised digital datum to replace a first digital datum by summing the first digital datum and a digital datum following the first digital datum; generating a second revised digital datum to replace a second digital datum by summing the first revised digital datum and the second digital datum, wherein the second digital datum follows the first revised digital datum; and continuing to generate revised digital sensing data until a last revised digital datum is generated.

### BACKGROUND OF THE INVENTION

1. Field of the Invention

The present invention relates to a touch panel apparatus, and more particularly, to a method for providing digital sensing data for a touch panel apparatus.

2. Description of the Related Art

A touch panel is an electronic display device that can sense the presence and location of a touch or multiple touches within a display area. A user can thereby directly interact with the apparatus having the touch panel without using a keyboard or mouse. In this way, the operation of the apparatus having the touch panel is much more intuitive.

FIG. 1 shows a typical touch panel apparatus 100, wherein a touch panel 110 is connected to and detected by a touch panel IC 120. The touch panel IC 120 comprises a pin interface 122, a channel control block 124, a logic control block 126 and an ADC module 128. The pin interface 122 is the interface between the touch panel IC 120 and the touch panel 110 and serves to send a driving signal to the touch panel 110 and receive a sensing signal from the touch panel 110. The channel control block 124 serves as a functional block for analog signal processing, such as sample and hold control signal processing, before the ADC module 128. The ADC module 128 converts analog signals to digital signals. The logic control block 126 is configured to analyze the digital signals provided by the ADC module 128 and to control the functional behavior of the channel control block 124.

Typically, the channel control block 124 comprises a plurality of operational amplifiers to simultaneously amplify multiple sensing signals from the touch panel 110. The display area of the touch panel 110 is segmented into multiple columns, wherein each column comprises a series of sensing areas. The plurality of operational amplifiers can sense the series of sensing areas in one column simultaneously. After multiple sensing operations, a table of sensing data covering the touch panel 110 is obtained.

FIG. 2 shows a series of single-ended mode operational amplifiers 210 connected to the touch panel 110 (the logic blocks therebetween are omitted for clarity). As shown in FIG. 2, the series of single-ended mode operational amplifiers 210 serves to amplify sensing signals from a series of sensing areas of the touch panel 110 adjacent to each other, wherein each single-ended mode operational amplifier 210 is configured to sense a corresponding sensing area. Each single-ended mode operational amplifier 210 compares a reference voltage and the sensing signal to provide an amplified signal.

FIG. 3 shows a series of differential mode operational amplifiers 310 connected to the touch panel 110 (the logic blocks therebetween are omitted for clarity). As with the series of single-ended mode operational amplifiers 210, the series of differential mode operational amplifiers 310 serve to amplify sensing signals from a series of sensing areas of the touch panel 110 adjacent to each other. Unlike the series of single-ended mode operational amplifiers 210, however, each differential mode operational amplifier 310 compares two adjacent sensing signals to provide an amplified signal.

FIG. 4 shows a table of sensing data provided by the series of single-ended mode operational amplifiers 210, wherein the dark areas denote the sensing data above a threshold value. FIG. 5 shows a table of sensing data provided by the series of differential mode operational amplifiers 310, wherein the dark areas denote the sensing data above a threshold value. By comparing FIGS. 4 and 5, it can be seen that the sensing data provided by the series of single-ended mode operational amplifier 210 is more differentiable for later process such as touched points detection, especially in the middle area of the area being touched in the touch panel 110, than the sensing data provided by the series of differential mode operational amplifiers 310. However, the sensing data provided by the series of single-ended mode operational amplifiers 210 contains more noise than the sensing data provided by the series of differential mode operational amplifiers 310.

Therefore, there is a need to design a signal processing algorithm to maintain the low noise signal quality provided by differential mode operational amplifiers that still provides differentiable sensing data by single-ended mode operational amplifiers.

### SUMMARY OF THE INVENTION

The method for providing digital sensing data for touch panel apparatus according to one embodiment of the present invention comprises the steps of: collecting a stream of digital sensing data from a plurality of operational amplifiers of a touch panel apparatus; generating a first revised digital datum to replace a first digital datum by summing the first digital datum and a digital datum following the first digital datum; generating a second revised digital datum to replace a second digital datum by summing the first revised digital datum and the second digital datum, wherein the second digital datum follows the first revised digital datum; and continuing to generate revised digital sensing data until a last revised digital datum is generated.

The method for providing digital sensing data for touch panel apparatus according to another embodiment of the present invention comprises the steps of: collecting a stream of digital sensing data from a plurality of operational amplifiers of a touch panel apparatus; generating a first revised digital datum by summing a first digital datum of the stream and a second digital datum following the first digital datum; generating a second revised digital datum by summing the first revised digital datum and a third digital datum following the second digital datum; and continuing to generate revised digital sensing data until a last revised digital datum is generated.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes as those of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon referring to the accompanying drawings of which:

FIG. 1 shows a typical touch panel apparatus;

FIG. 2 shows a plurality of single-ended mode operational amplifiers;

FIG. 3 shows a plurality of differential mode operational amplifiers;

FIG. 4 shows a table of sensing data provided by a series of single-ended mode operational amplifiers;

FIG. 5 shows a table of sensing data provided by a series of differential mode operational amplifiers;

FIG. 6 shows a partial block diagram of a touch panel apparatus according to an embodiment of the present invention;

FIG. 7 shows a flow chart of the method for providing digital sensing data for a touch panel apparatus according to an embodiment of the present invention;

FIG. 8A shows a table of sensing data according to an embodiment of the present invention;

FIG. 8B shows a template for the table of sensing data illustrated in FIG. 8A;

FIG. 9 shows a table of sensing data according to another embodiment of the present invention;

FIG. 10 shows a table of sensing data according to another embodiment of the present invention;

FIG. 11 shows a table of sensing data according to another embodiment of the present invention;

FIG. 12 shows a table of predetermined values according to another embodiment of the present invention; and

FIG. 13 shows a table of sensing data according to another embodiment of the present invention.

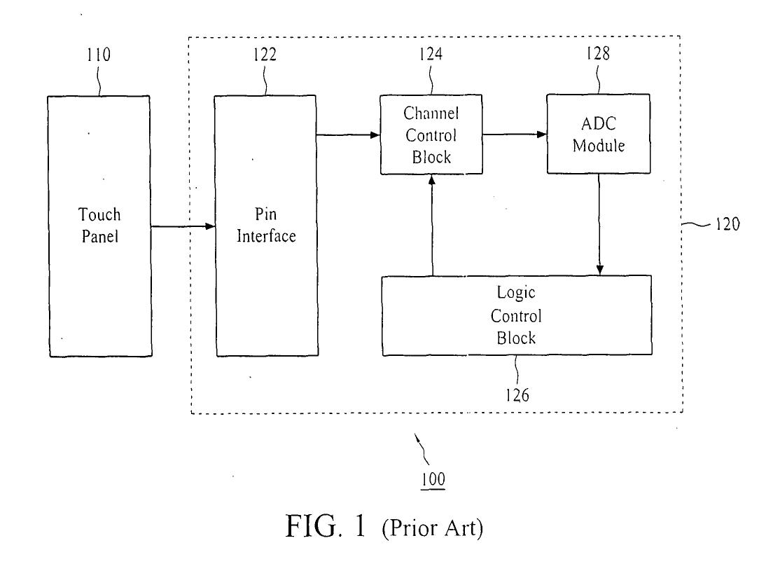

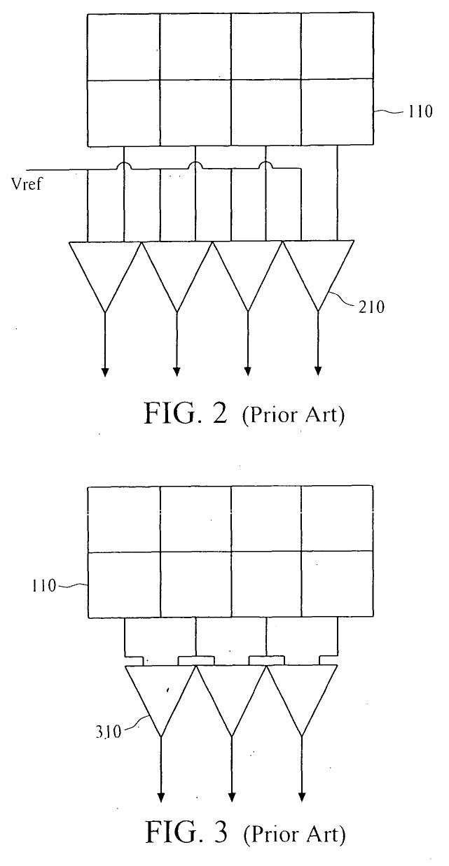

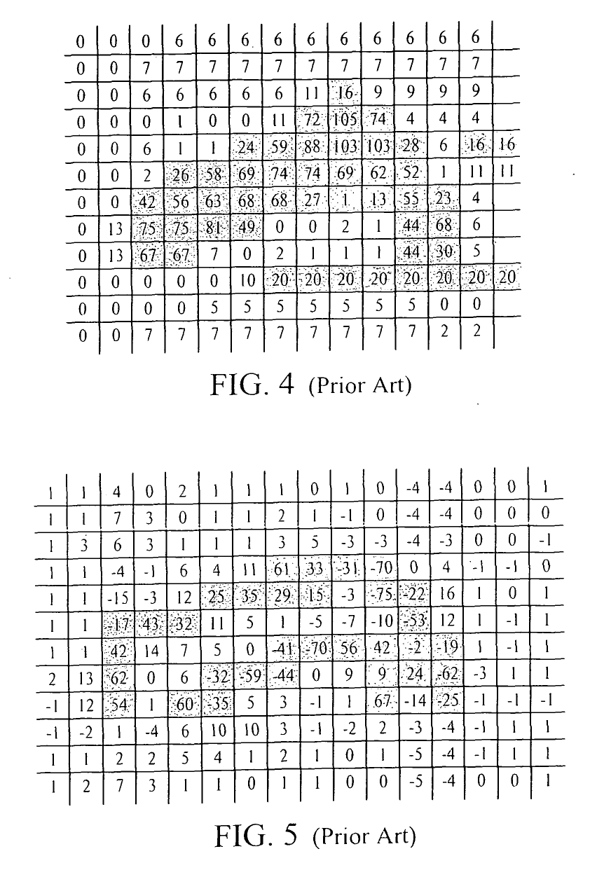

### DETAILED DESCRIPTION OF THE INVENTION

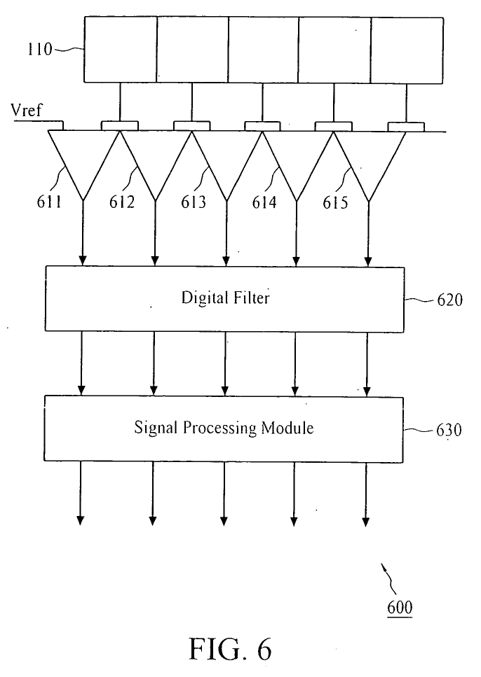

FIG. 6 shows a partial block diagram of a touch panel apparatus according to an embodiment of the present invention. As shown in FIG. 6, the touch panel apparatus 600 comprises a stream of operational amplifiers 611 to 615 connected to a touch panel 110, a digital filter 620 and a signal processing module 630. The digital filter 620 is configured to convert the analog signal provided by the operational amplifiers 610 to digital data. The signal processing module 630 is configured to perform the method for providing digital sensing data for touch panel apparatus disclosed by this invention. As shown in FIG. 6, the first operational amplifier of the stream of operational amplifiers 611 is a single-ended mode operational amplifier, while the remaining operational amplifiers 612 to 615 are differential mode operational amplifiers.

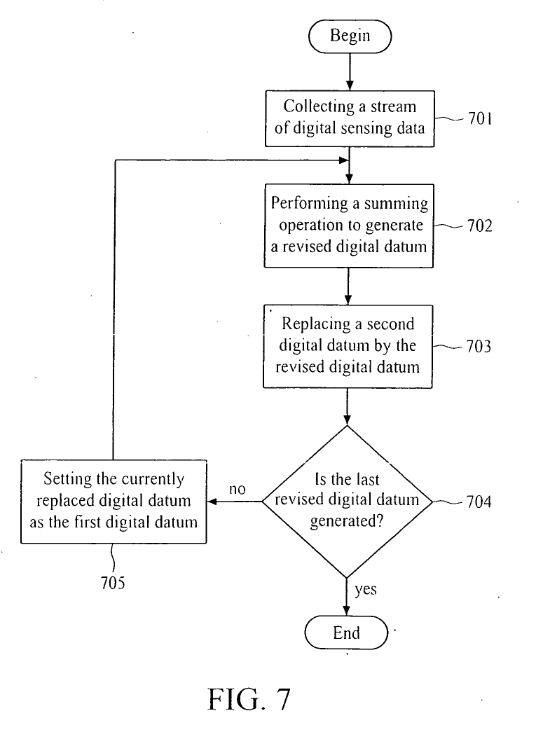

FIG. 7 shows a flow chart of the method for providing digital sensing data for a touch panel apparatus according to an embodiment of the present invention. In step 701, a stream of digital sensing data is collected from a plurality of operational amplifiers of a touch panel apparatus, and then step 702 is executed. In step 702, an operation of summing a first digital datum and a second digital datum following the first digital datum is performed to generate a revised digital datum, and then step 703 is executed. In step 703, the second digital datum is replaced by the revised digital datum, and step 704 is executed. In step 704, it is determined whether the last revised digital datum has been generated. If the last revised digital datum has been generated, the current method is finished; otherwise, step 705 is executed. In step 705, the currently replaced digital datum is set as the first digital datum, and step 702 is executed.

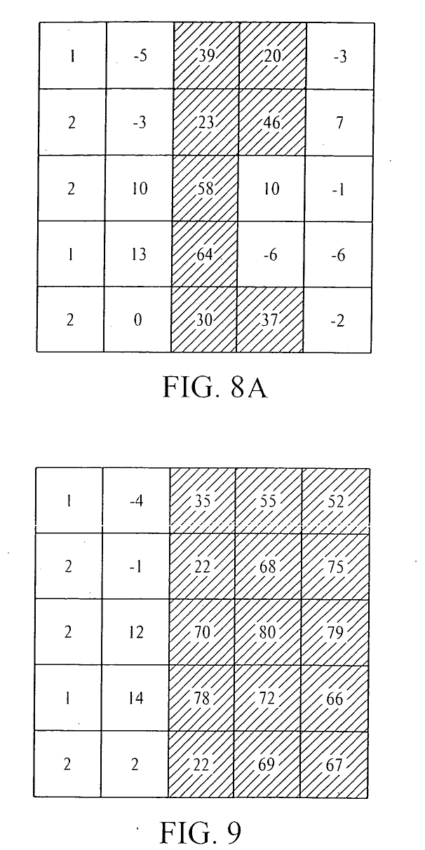

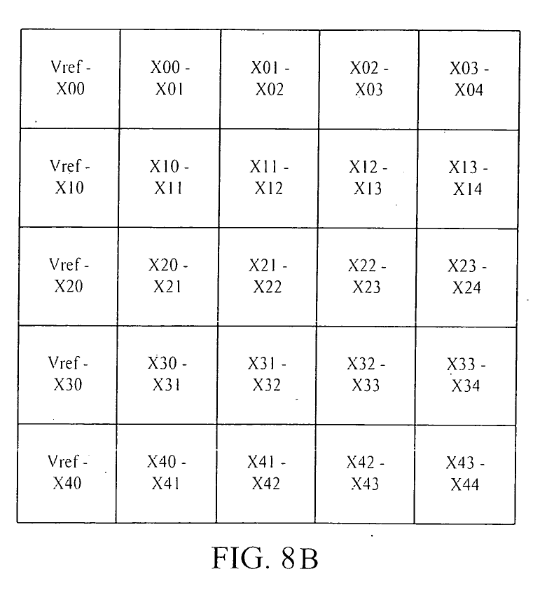

FIG. 8A shows a table of sensing data provided by the stream of operational amplifiers 611 to 615, wherein the dark areas denote the sensing data above a threshold value. As shown in FIG. 8B, the leftmost digital datum in the first row is provided by the operational amplifier 611, and can be denoted as (Vref-X00). The other data in the first column are provided by the operational amplifiers 612 to 615, and can be respectively denoted as (X00-X01), (X01-X02), (X02-X03) and (X03-X04). Similarly, the other rows of the table can be denoted in the same manner. By applying the method shown in FIG. 7, in step 702, the leftmost digital datum in the first row is set as the first digital datum, and the digital datum following the first digital datum is set as the second digital datum. Accordingly, a revised digital datum is generated by summing the first digital datum and the second digital datum. That is, the revised digital datum is set to 1+(−5)=−4, wherein the revised digital datum can also be denoted as (Vref-X00)+(X00-X01)=(Vref-X01). In step 703, the second digital datum, which can be denoted as (X00-X01), is replaced by the revised digital datum, which can be denoted as (Vref-X01). In step 705, the revised digital datum is set as the first digital datum, and step 702 is executed again. After the repetition of the summing operation, the digital data in the first row can be denoted as follows: (Vref-X00), (Vref-X01), (Vref-X02), (Vref-X03) and (Vref-X04).

FIG. 9 shows a table of sensing data after applying the method shown in FIG. 7, wherein the dark areas denote the sensing data above a threshold value. Comparing FIGS. 8A and 9, it can be seen that FIG. 8A only shows the boundary (denoted by the dark area) between the display area being touched and the display area not being touched, whereas FIG. 9 shows the whole area (denoted by the dark area) covering the display area being touched. Accordingly, the sensing data is more differentiable for palm detection.

While applying the procedure shown above, noise caused by the single-ended mode operational amplifier 611 may be inadvertently introduced. Alternatively, the method shown in FIG. 7 can be applied in a different way. That is, in step 702, the second digital datum from the left in the first column is set as the first digital datum, and the digital datum following the first digital datum is set as the second digital datum. Accordingly, after the repetition of the summing operation, the digital data in the first row can be denoted as follows: (Vref-X00), (X00-X01), (X00-X02), (X00-X03) and (X00-X04). As can be seen, the noise caused by the single-ended mode operational amplifier 611 is greatly reduced. FIG. 10 shows a table of sensing data after applying the method shown in FIG. 7 according to this setting.

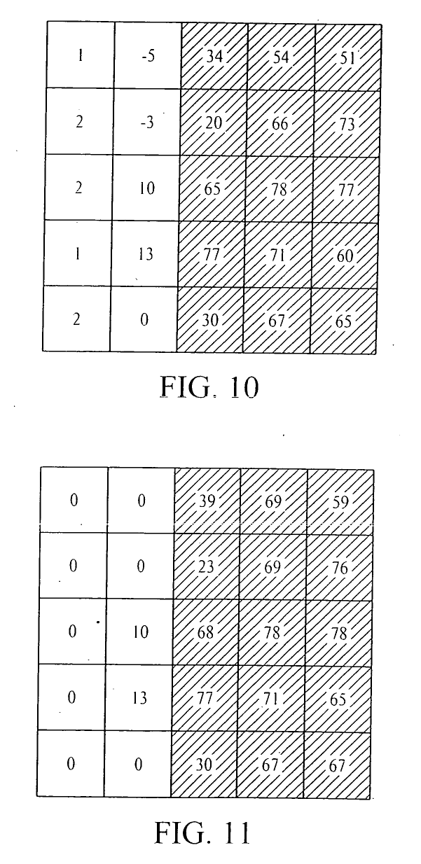

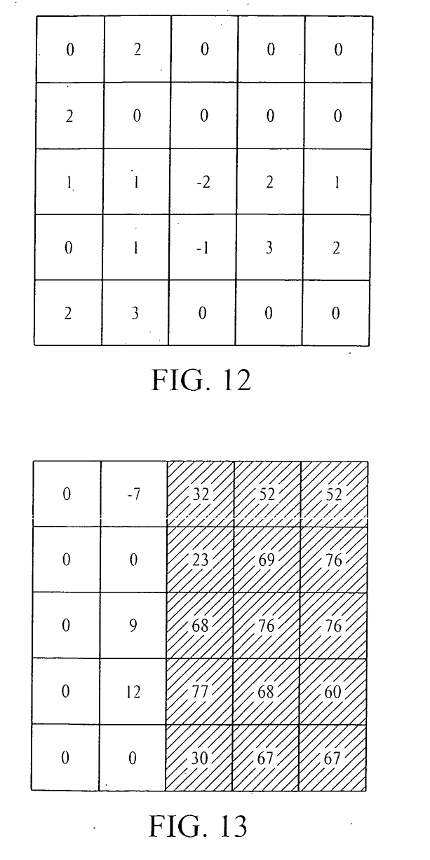

To further reduce the noise introduced among two adjacent sensing data, an operation of substituting each sensing data smaller than a threshold value with zero can be performed. Referring to the table shown in FIG. 8A, which is the original sensing data provided by the operational amplifiers 611 to 615, all the sensing data that have absolute values smaller than six are substituted by zero. Accordingly, the sensing data in the first column which have absolute values smaller than six, including one, minus five and minus three, are substituted by zero. FIG. 11 shows a table of sensing data after applying the method shown in FIG. 7 according to this setting.

To further improve the method shown in FIG. 7, the sensing data detected by the operational amplifiers 611 to 615 when the touch panel 110 is not touched are stored to provide bias data. FIG. 12 shows a table of predetermined values according to another embodiment of the present invention. Accordingly, an operation of subtracting a corresponding predetermined value from each digital sensing data can be performed. Referring to the table shown in FIG. 8A, which is the original sensing data provided by the operational amplifiers 611 to 615, a subtraction operation is performed between the table shown in FIG. 8A and the table shown in FIG. 12. Subsequently, all the sensing data that have absolute values smaller than a threshold value are substituted by zero, and the method shown in FIG. 7 is applied normally. FIG. 12 shows a table of sensing data after applying the method shown in FIG. 7 according to this setting.

In conclusion, the present invention provides a method for providing digital sensing data for a touch panel apparatus that performs signal processing on sensing data provided by differential mode operational amplifiers, which introduce less noise than single-ended mode operational amplifiers. After applying the method provided by the present invention, the identification of the sensing data is enhanced.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for providing digital sensing data for a touch panel apparatus, comprising the steps of:
collecting a stream of digital sensing data from a plurality of operational amplifiers of a touch panel apparatus;
generating a first revised digital datum to replace a first digital datum by summing the first digital datum and a digital datum following the first digital datum;
generating a second revised digital datum to replace a second digital datum by summing the first revised digital datum and the second digital datum, wherein the second digital datum follows the first revised digital datum; and
continuing to generate revised digital sensing data until a last revised digital datum is generated.

2. The method of claim 1, further comprising the step of:
substituting each digital sensing data in the stream smaller than a threshold value with zero.

3. The method of claim 1, further comprising the step of:
subtracting a corresponding predetermined value from each digital sensing data in the stream.

4. The method of claim 1, wherein the digital datum at the start of the stream is provided by a single-ended mode operational amplifier, the remaining digital sensing data are provided by differential mode operational amplifiers, and the first revised digital datum is generated by summing the digital datum provided by the single-ended mode operational amplifier and a digital datum provided by a differential mode operational amplifier.

5. The method of claim 1, wherein the digital datum at the start of the stream is provided by a single-ended mode operational amplifier, the remaining digital sensing data are provided by differential mode operational amplifiers, and the first revised digital datum is generated by summing two digital sensing data provided by differential mode operational amplifiers.

6. A method for providing digital sensing data for a touch panel apparatus, comprising the steps of:
collecting a stream of digital sensing data from a plurality of operational amplifiers of a touch panel apparatus;
generating a first revised digital datum by summing a first digital datum of the stream and a second digital datum following the first digital datum;
generating a second revised digital datum by summing the first revised digital datum and a third digital datum following the second digital datum; and
continuing to generate revised digital sensing data until a last revised digital datum is generated.

7. The method of claim 6, further comprising the step of:
substituting each digital sensing data in the stream smaller than a threshold value with zero.

8. The method of claim 6, further comprising the step of:
subtracting a corresponding predetermined value from each digital sensing data in the stream.

9. The method of claim 6, wherein the digital datum at the start of the stream is provided by a single-ended mode operational amplifier, the remaining digital sensing data are provided by differential mode operational amplifiers, and the first revised digital datum is generated by summing the digital datum provided by the single-ended mode operational amplifier and a digital datum provided by a differential mode operational amplifier.

10. The method of claim 6, wherein the digital datum at the start of the stream is provided by a single-ended mode operational amplifier, the remaining digital sensing data are provided by differential mode operational amplifiers, and the first revised digital datum is generated by summing two digital sensing data provided by differential mode operational amplifiers.
